(19) United States
(12) Patent Application Publication
(10) Pub. No.: US 2013/0247713 A1
(43) Pub. Date: Sep. 26, 2013

(54) QUICK RELEASE PEDAL

(71) Applicant: WEN-JUI CHENG, CHIAYI COUNTY (TW)

(72) Inventor: WEN-JUI CHENG, CHIAYI COUNTY (TW)

(21) Appl. No.: 13/427,994

(22) Filed: Mar. 23, 2012

(51) Int. Cl. B62M 3/08

(52) U.S. Cl. 74/594.4

(57) ABSTRACT

A quick release pedal is revealed. The quick release pedal includes a pedal shaft for being assembled with a pedal, a connection member, a positioning pin, and a moving part. The pedal shaft is disposed with a fastening part and a mounting slot. A mounting hole corresponding to the mounting slot is arranged at the connection member. The positioning pin includes a circular groove, a mounting part corresponding to the mounting hole, and a locking part. The moving part is sleeved over a wall surface of the connection member arranged with the mounting hole. At least one long slot corresponding to the locking part of the positioning pin is disposed on the moving part. At least one magnetic part is mounted between the moving part and the wall surface. Thus assembly and disassembly of the pedal is more convenient and faster by the magnetic part attached to the wall surface.

### BACKGROUND OF THE INVENTION

1. Field of the Invention

The present invention relates to a pedal, especially to a quick release pedal that is faster and more convenient during disassembly, and having more competitive cost of manufacturing and processing than a conventional pedal.

2. Description of Related Art

In order to meet different requirements, users may buy different kinds of bicycles. This is not cost effective and the bicycles occupy a lots space. Thus without losing the beauty and stability of the bicycles, each part of the bicycle can be modified replaced becomes a trend in the industry. As to a quick release pedal, it can be replaced according to users' requirements. For example, the original pedal is replaced by an anti-skid pedal with larger surface for climbing hills. Thus the user will not go into a skid while adding power and accidents are avoided. As riding on the road, a light pedal with smaller surface area is used for faster speed and better performance.

Refer to Taiwanese Pat. Pub. No. M369915 “quick release pedal” filed at Jul. 17, 2009, the quick release pedal has been widely used for several years. The hidden design of the quick release pedal does prevent users from getting injured or hurt by their legs kicking an operation block. Moreover, the pedal is not easily to fall off due to users' neglect. However, when the user intend to pull the operation block out of the receiving slot, the user having larger/wider fingers is difficult to apply force and the disassembly of the pedal is not fast and convenient enough. Moreover, one side of a fixed part of the device is an even and flat surface whose processing is more difficult. Thus the cost of manufacturing and processing is increased. Thus there is room for improvement and a need to provide a quick release pedal having a novel design.

### SUMMARY OF THE INVENTION

Therefore it is a primary object of the present invention to provide a quick release pedal that is faster and more convenient during the disassembly than a conventional pedal. Moreover, the cost of manufacturing and processing the quick release pedal is more competitive.

In order to achieve the above object, a quick release pedal of the present invention includes a pedal shaft for being assembled with a pedal, a connection member that is passed through by the pedal shaft for fixing the pedal shaft, a positioning pin, and a moving part. The pedal shaft is disposed with a fastening part at one end and a mounting slot near the fastening part. The connection member is arranged with a receiving hole on one end and a positioning part on the other end thereof. The receiving hole is passed through by the pedal shaft and the shape of the positioning part is corresponding to the shape of the fastening part. The connection member further includes a mounting hole corresponding to the mounting slot while the mounting hole and the receiving hole are communicated with each other. The positioning pin includes a mounting part corresponding to the mounting hole on one end, a locking part on the other end, and a circular groove disposed concavely between the mounting part and the locking part. The mounting part is mounted into the mounting hole. The moving part is sleeved over a wall surface of the connection member arranged with the mounting hole. At least one long slot having a narrow opening and corresponding to the locking part of the positioning pin is disposed on an inner wall of the moving part. At least one magnetic part is mounted between the moving part and the wall surface. When the magnetic part is attached to the wall surface disposed with the mounting hole by magnetic force, the mounting part of the positioning pin on the moving part is forced to be mounted in the mounting slot. Thus the pedal shaft is connected with the connection member firmly, not easy to fall off.

When users want to replace the pedal, they only need to apply force to the moving part to release the moving part from the connection member. And the mounting part is also released from the mounting slot of the pedal shaft. Thus not only the assembly and the disassembly of the present invention are faster and more convenient. The problem of the conventional quick release pedal that is more difficult to be applied with force and disassembled by users with larger/wider fingers can be solved.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive view of an embodiment according to the present invention;

FIG. 2 is a cross sectional view of a positioning pin assembled with a moving part in an embodiment according to the present invention;

FIG. 3 is a cross sectional view taken at one line of an assembled embodiment according to the present invention;

FIG. 4 is another cross sectional view taken at another line of an assembled embodiment according to the present invention;

FIG. 5 is a schematic cross sectional view showing a positioning pin being released from the mounting slot in an assembled embodiment according to the present invention;

FIG. 6 is another schematic cross sectional view showing a positioning pin being released from the mounting slot in an assembled embodiment according to the present invention.

### DETAILED DESCRIPTION OF THE PREFERRED EMBODIMENT

A quick release pedal of the present invention includes a pedal shaft 1 assembled with a pedal 2, a connection member 3 (connector), a positioning pin 4, a moving part 5, two magnetic parts 6 and a ring 7. The pedal shaft 1 is assembled with the pedal. A fastening part 11 is disposed on one end of the pedal shaft 1 and a mounting slot 12 is arranged at the fixing part, near the fastening part 11.

The connection member 3 consists of a receiving hole 31 on one end and a positioning part 32 on the other end thereof. The receiving hole 31 allows the pedal shaft 1 to pass through and the shape of the positioning part 32 is corresponding to the shape of the fastening part 11. The connection member 3 is further arranged with a mounting hole 33 corresponding to the position of the mounting slot 12. The mounting hole 33 and the receiving hole 31 are communicated with each other. In this embodiment, the fastening part 11 is a polygonal column and the positioning part 32 is a polygonal hole whose shape is corresponding to the fastening part 11. Moreover, a threaded part 34 is disposed on an outer wall of the positioning part 32. The threaded part 34 is threaded with a threaded hole (not shown in figure) of a bike crank (not shown in figure).

The positioning pin 4 includes a circular groove 41 disposed concavely, a mounting part 42 on one end, and a locking part 43 on the other end thereof. The circular groove 41 is arranged between the mounting part 42 and the locking part 43. The mounting part 42 is corresponding to and mounted in the mounting hole 33.

The moving part 5 is sleeved over a wall surface 35 where the mounting hole 33 is arranged at. A long slot 51 having a narrow opening 511 and corresponding to the locking part 43 of the positioning pin 4 is disposed on an inner wall of the moving part 5. At least one magnetic part 6 is mounted between the moving part 5 and the wall surface 35 with the mounting hole 33. When the magnetic part 6 is attached to the wall surface 35 by magnetic force, the positioning pin 4 is forced to be mounted in the mounting slot 12. In this embodiment, two receiving slots 52 are set beside the long slot 51 respectively and the receiving slot 52 is for mounting the magnetic part 6. As to the ring 7, it is disposed between the moving part 5 and the bike crank.

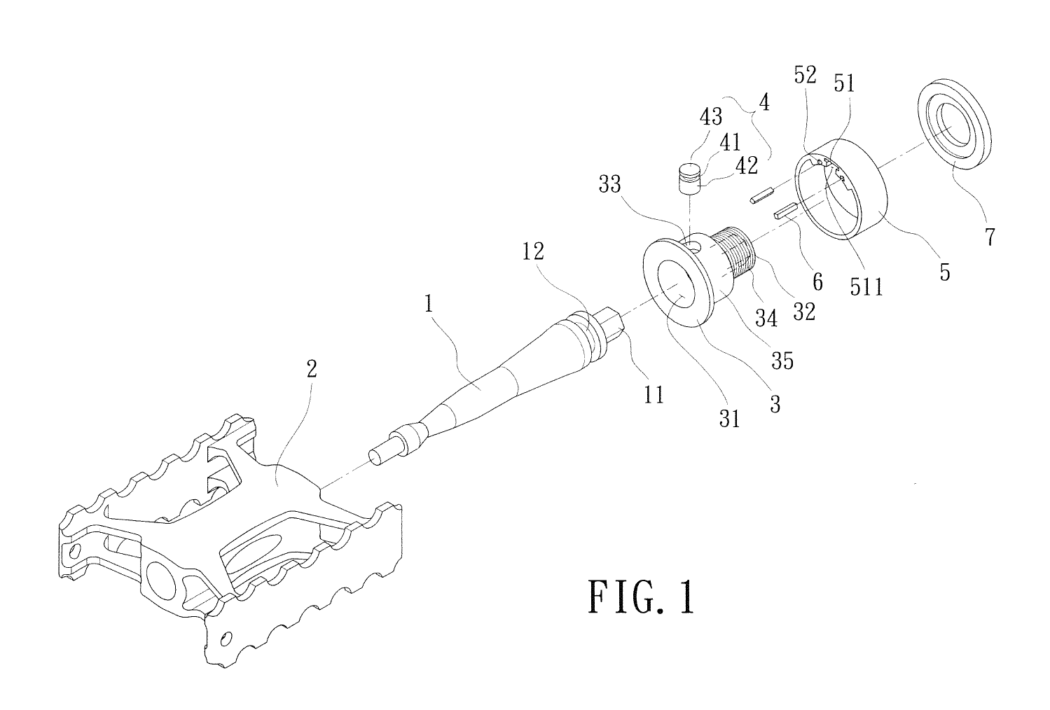

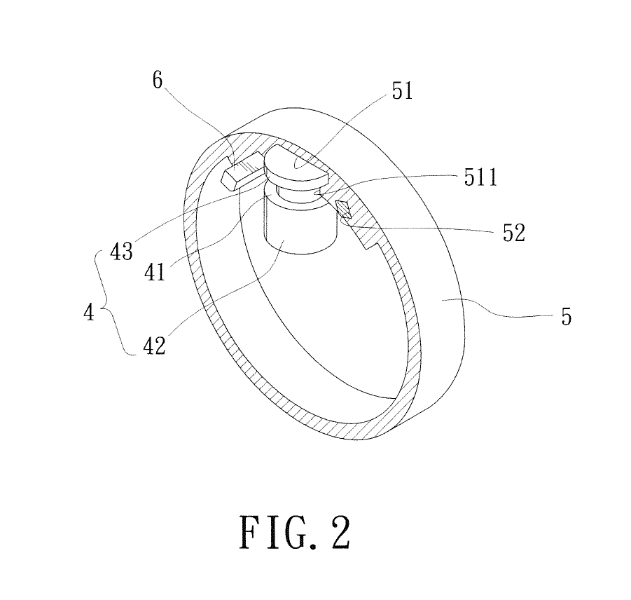

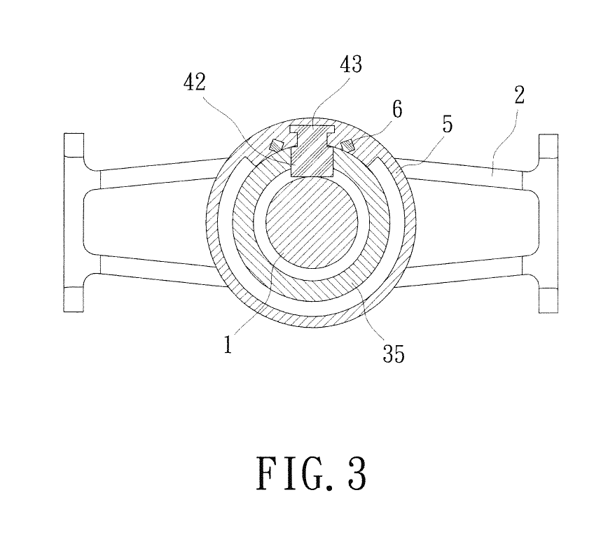

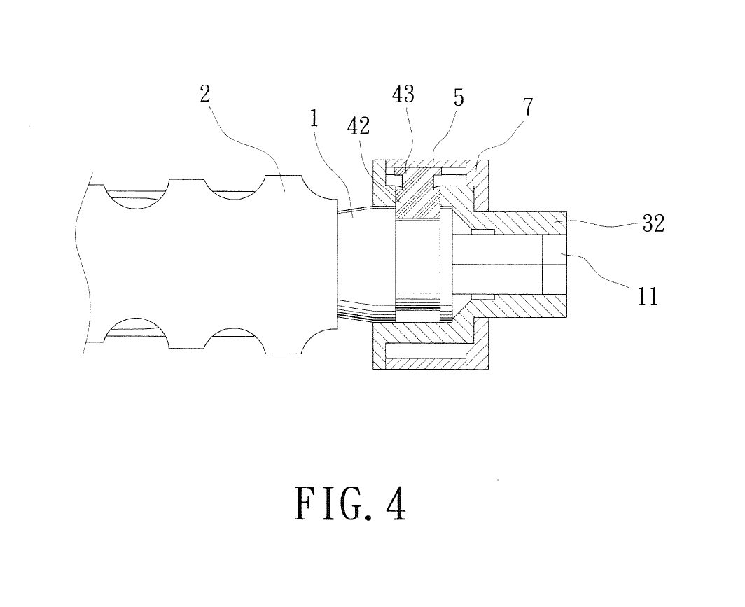

While being assembled, refer from FIG. 2 to FIG. 4, firstly the positioning pin 4 is connected with the moving part 5 by mounting the locking part 43 of the positioning pin 4 into the long slot 51 of the moving part 5. The circular groove 41 on the positioning pin 4 is disposed correspondingly to the narrow opening 511 of the long slot 51. Then the two magnetic parts 6 are respectively mounted into the receiving slots 52 of the moving part 5. Next the pedal 2 is assembled with the pedal shaft 1. The fastening part 11 of the pedal shaft 1 is inserted into the receiving hole 31 of the connection member 3 and fixed by the positioning part 32. After being assembled, the fastening part 11 is unable to be rotated in relation to the positioning part 32. And the mounting slot 12 of the pedal shaft 1 is corresponding to the mounting hole 33 of the connection member 3. Back to FIG. 1, the moving part 5 already assembled with the positioning pin 4 is sleeved over the wall surface 35 with the mounting hole 33. And the mounting part 42 of the positioning pin 4 is mounted into the mounting hole 33 of the connection member 3. At this moment, the magnetic parts 6 on the moving part 5 are attached to the wall surface 35 disposed with the mounting hole 33 by magnetic force. The mounting part 42 of the positioning pin 4 assembled with the moving part 5 is locked in and fixed by the mounting slot 12 so that the pedal shaft 1 is fixed in the connection member 3 firmly, not easy to fall off. At last, the ring 7 is enclosed around the connection member 3. The quick-release pedal is threaded with the bike crank by the threaded part 34 of the connection member 3.

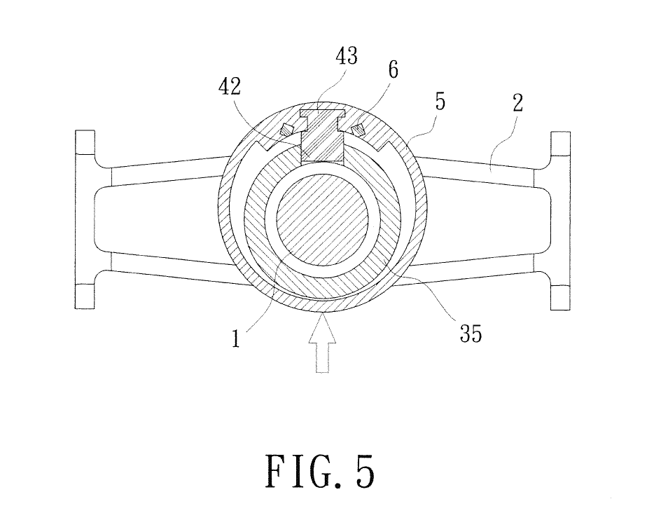

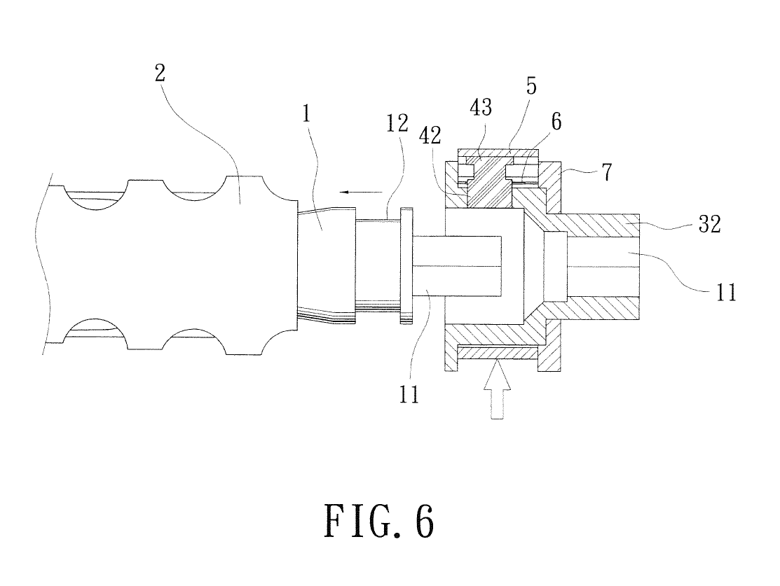

Refer to FIG. 5 and FIG. 6, users only need to apply force to the moving part 5 by their fingers when they need to replace the pedal 2 with the different one. In this embodiment, the moving part 5 is pushed by the force applied so as to release the magnetic part 6 from the wall surface 35. The moving part 5 and the positioning pin 4 are moved together. Thus the mounting part 42 of the positioning pin 4 is driven to be released from the mounting slot 12 of the pedal shaft 1 while the moving part 5 is moving. And the pedal shaft 1 can be pulled out and released so as to be assembled with a pedal 2 required.

In summary, compared with the technique available now, the magnetic part of the present invention is attached to the wall surface arranged with the mounting hole for magnetic force. Thus the positioning pin is pressed by the moving part and the mounting part of the positioning pin is passed through the mounting hole to be fixed and mounted in the mounting slot. Therefore the pedal shaft is fixed firmly in the connection member. When the user intends to replace the pedal, he only needs to apply force to the moving part to release the positioning pin from the connection member. The assembly and disassembly of the pedal is easy and convenient. Moreover, the problem that users with larger/wider fingers may have difficulty in applying force to the conventional quick release pedal can be solved.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A quick release pedal comprising:
a pedal shaft that is assembled with a pedal and disposed with a fastening part on one end and a mounting slot near the fastening part;
a connection member having a receiving hole on one end, a positioning part on the other end thereof and a mounting hole corresponding to the mounting slot; the receiving hole being passed through by the pedal shaft and a shape of the positioning part corresponding to a shape of the fastening part while the mounting hole and the receiving hole communicating with each other;
a positioning pin including a mounting part corresponding to and mounted in the mounting hole on one end, a locking part on the other end, and a circular groove disposed concavely between the mounting part and the locking part; and
a moving part that is sleeved over a wall surface of the connection member with the mounting hole and having a long slot with a narrow opening disposed on an inner wall thereof and corresponding to the locking part of the positioning pin;
wherein at least one magnetic part is mounted between the moving part and the wall surface of the connection member that is disposed with the mounting hole; the positioning pin is forced to be mounted in the mounting slot when the magnetic part is attached to the wall surface of the connection member with the mounting hole by magnetic force.

2. The device as claimed in claim 1, wherein at least one receiving slot is disposed on the inner wall of the moving part, at least one end of the long slot; the receiving slot is for mounting the magnetic part.

3. The device as claimed in claim 1, wherein a threaded part is arranged at an outer wall of the positioning part and the threaded part is threaded with a threaded hole of a bicycle crank.

4. The device as claimed in claim 1, wherein the fastening part is a polygonal column and the positioning part is a polygonal hole whose shape is corresponding to the fastening part.

5. The device as claimed in claim 1, wherein a ring is disposed between the moving part and a bicycle crank.
